(19) United States
(12) Patent Application Publication
(10) Pub. No.: US 2025/0018802 A1
(43) Pub. Date: Jan. 16, 2025

(54) AUTOMATIVE ENERGY RECOVERY SYSTEM FOR ELECTRIC VEHICLE

(71) Applicant: Caminos Obras Y Proyectos SL, Baleares Palma de Mallorca (ES)

(72) Inventor: Ronny VAN DEN BROECK, Baleares Palma de Mallorca (ES)

(73) Assignee: Caminos Obras Y Proyectos SL, Baleares Palma de Mallorca (ES)

(21) Appl. No.: 18/713,719

(22) PCT Filed: Nov. 29, 2022
(86) PCT No.: PCT/IB2022/061534

§ 371 Date: May 28, 2024

(30) Foreign Application Priority Data
Dec. 1, 2021 (BE) 2021/5930

(51) Int. Cl. B60L 8/00

(52) U.S. Cl. CPC B60L 8/006

(57) ABSTRACT

The invention concerns an energy recovery system for a vehicle.

### TECHNICAL FIELD OF THE INVENTION

The invention concerns an energy recovery system for a vehicle.

### BACKGROUND OF THE INVENTION

Different types of systems exist that can be used for energy recovery in vehicles.

US2011309786A1 describes an electrically powered, stand-alone, green electric vehicle, with a wind capturing and acceleration system used to drive at least one wind turbine or similar in order to generate electricity. It may also comprise solar and thermal energy collectors for the generation of electricity from solar and thermal energy sources. Such a vehicle may also comprise controls for the regulation and consolidation of all electrical energy sources and the selective transfer of electrical energy to the above-mentioned electric motor as a source of power or to recharge the batteries of such an electrically powered vehicle.

A similar system is described in Japanese patent reference JP2002359903, which also uses a wind capturing system fitted with one or more wind turbines to charge a battery in the vehicle. As explained in further detail below, a configuration with wind turbines placed in separate cavities within the wind capturing system has clear practical disadvantages in implementation, while a system designed according to the invention also improves efficiency.

A disadvantage of prior wind capturing and acceleration systems is that with a predominantly horizontal orientation of the turbine blades, as shown in US2011309786, JP2002359903, CH702904 and US2002153178, the wind turbine always has an internal transmission mechanism connected to the turbine's generator to allow the turbine rotor's rotational speed to be increased when wind flow is too low and thereby ensure sufficient revolutions per minute for the generator to produce sufficient electrical energy, as a consequence of which all or most of the wind's force may not be utilised and converted into electricity.

### SUMMARY OF THE INVENTION

The purpose of the invention is to provide an energy recovery system that makes it possible to accelerate wind flow.

To this end, the invention provides for an automotive energy recovery system for the conversion of wind energy into electricity, this energy recovery system comprising at least a rechargeable battery, a wind collection device for the conversion of wind energy into electricity, a control module to regulate the transfer of electricity generated by the wind collection device to electricity-consuming devices in the vehicle and/or the rechargeable battery, whereby the wind collection device comprises a housing forming a flow passage, at least two ventilators within this flow passage, at least one deflector to direct and accelerate air flowing through the flow passage towards the at least two ventilators, and at least one energy converter for the conversion of the air's kinetic energy into electricity. Unlike turbines in accordance with prior art, where the blades have a horizontal orientation (parallel to the ground) within the wind collection device, it is characteristic of the invention that the turbine blades for the energy converter (ventilator) within the wind collection device are oriented vertically (upright). The horizontal plane in this reference is a plane parallel to the top and bottom of the housing, where the orientation of the housing's top and bottom correspond with the vehicle's top (b) and bottom (o).

The invention is based on the understanding that, in such an arrangement of the energy converters, use of a deflector to narrow the wind collection device's flow passage accelerates the flow of captured air through the passage. Due to the accelerated air flow, the ventilator rotor speed increases and more kinetic energy from the flow of air is converted into electricity and transferred to electricity-consuming devices such as a motor by the control module.

Preferably, the wind collection device housing has an axis of symmetry determining a direction of the air flow. The symmetrical design of the housing ensures that the air flow is captured uniformly.

Preferably, the ventilator comprises a rotor shaft located along the wind collection device housing's axis of symmetry. The position of the rotor shaft ensures that the ventilator's placement inside the housing is symmetrical.

Preferably, the wind collection device's deflector is upwind relative to the ventilators. The deflector causes a narrowing of the flow passage in the housing. The deflector's placement ensures that the air flow applies a force directly to the ventilator blades in the correct orientation to fully utilise the air flow's kinetic energy and, preferably, transfer the flow to subsequent ventilators.

Preferably, the deflector is positioned at an angle (α) relative to one side of the housing that is less than 50°. Such a deflector angle reduces the effects of turbulence inside the housing. This ensures more efficient acceleration of the air flow.

Preferably, the deflector reduces the flow passage to ⅓ of its surface area.

Preferably, the number of deflectors is equal to the number of ventilators. An equal number of deflectors ensures more uniform transmission of the air flow to the next set of ventilators and at least a more uniform air speed.

Preferably, each deflector is upwind relative to each of the ventilators. The placement of each deflector ensures that the air flow applies a force directly to the ventilator blades in the correct orientation to fully utilise the wind's kinetic energy and, preferably, transfer the flow to subsequent ventilators.

Preferably, the wind collection device's deflectors are positioned on the same side of the housing. This placement ensures that at least one side of the housing has no deflectors, increasing the air flow rate.

Preferably, one of the wind collection device's ventilators is positioned in between two deflectors.

Preferably, the orientation of the ventilator rotor shaft is substantially perpendicular to the axis of symmetry and the air flow. This central positioning of the ventilator rotor shaft within the wind collection device defines the type of ventilator. Preferably, the ventilators are vertical axis wind turbines (VAWT) with rotor shafts perpendicular (at right angles) to the axis of symmetry and the air flow (i.e. on the housing's horizontal plane). In this embodiment, the VAWT turbine blades are oriented vertically within the wind collection device (upright). In combination with the aforementioned deflectors, this configuration provides the most efficient energy conversion.

Preferably, the wind collection device's energy converter is located along the ventilator rotor shaft. By positioning the energy converter directly along the ventilator's axis of rotation, less electricity is lost.

Preferably, at least an operational connection is provided between one or more energy converters and the rechargeable battery of the vehicle.

Preferably, the wind collection device's ventilator comprises at least one rotating blade. This blade rotates the ventilator due to the generation of kinetic energy.

Preferably, the rotating blade of the wind collection device's ventilator is a cambered airfoil. The cambered blade deflects the flow of air more smoothly, reducing wall effects on the flow by reducing the angle of attack.

Certain and preferred embodiments of the invention are described in the attached independent and dependent claims. Features of the dependent claims may be combined with those of independent and other dependent claims, where applicable and not only as expressly indicated in the claims.

The above and other features, functions and benefits of the present invention will be reflected in the following detailed description, in conjunction with the accompanying images, which serve as examples for the principles of the invention. This description is given as an example only, without limiting the scope of the invention. The reference numbers below refer to the accompanying images.

### BRIEF DESCRIPTION OF THE FIGURES

With specific reference to the figures, it must be emphasised that the specifics shown serve only as examples and for the purposes of illustrating the discussion of the various forms of embodiment of the present invention. They are being proposed with the aim of furnishing what is regarded as the most useful and immediate description of the principles and conceptual aspects of the invention. No attempt has been made in this respect to show more structural details of the invention other than those necessary for a fundamental understanding of the invention. The description in combination with the figures clarifies how the various forms of the invention can be executed in practice for experts in the field.

The invention will now be described in more detail based on an example of an embodiment as shown in the drawing.

In the drawing:

FIG. 1 provides a side view of an automotive energy recovery system for the conversion of wind energy into electricity according to an embodiment of the invention;

FIG. 2 provides an overhead view of a wind collection device for the conversion of wind energy into electricity according to an embodiment of the invention;

FIG. 3 provides an overhead view of a wind collection device for the conversion of wind energy into electricity according to an embodiment of the invention;

FIG. 4 provides an overhead view of a wind collection device ventilator for the conversion of wind energy into electricity according to an embodiment of the invention.

In the drawing, the same reference number refers to the same or an analogous element.

### DETAILED DESCRIPTION OF THE INVENTION

The present invention shall be described with regard to certain embodiments and certain images, but is not limited to these, except by the claims. The images, as further described, are only schematic and non-exhaustive. In the images, certain elements may not be drawn to scale for illustrative purposes. Absolute and relative dimensions do not correspond to the actual limitations in practice.

Moreover, the terms first, second, further and similar in the description and in the claims are used to distinguish between similar elements and not necessarily for the description of a series, whether in time, space, order or in any other way. It is understood, however, that the terms used in this way are interchangeable under appropriate circumstances and that the embodiments of this invention can be applied in an order other than that described or illustrated herein.

The term “comprises” as used in the claims should not be interpreted as limited to the following resources; other elements or steps are not excluded. It refers to the presence of the said features, whole numbers, steps or parts listed, but does not exclude the presence or addition of one or more other features, whole numbers, steps, parts or groups. The scope of the phrase “a product comprising A and B” should therefore not be limited to devices consisting solely of parts A and B. This means that the relevant parts of the product are A and B and other parts such as C may be present in the present invention.

Where reference is made in this specification to “one embodiment” or “an embodiment”, this means that a particular function or structure, or a particular feature relating to the embodiment, is included in at least one embodiment of the present invention. Where “in one embodiment” or “in an embodiment” is mentioned at different points in this specification, this does not necessarily refer to the same embodiment. In addition, certain functions, structures or features may be combined in any appropriate manner, as is considered applicable to an ordinary professional in one or more embodiments.

Moreover, the description of examples of embodiments and different features of the invention may sometimes be grouped in one embodiment, image or description in order to streamline the disclosure and explain one or more inventive aspects. However, it should not be concluded from this method of disclosure that the claimed invention requires more features than is explicitly stated in each claim. As the following claims show, the inventive aspects are more likely to be represented by a subset than by all the features of one embodiment mentioned 10 above. For this reason, the claims that follow the detailed description are explicitly included in this detailed description, whereby each claim is a separate embodiment of this invention.

Although some of the embodiments described herein comprise some but not other features of other embodiments, combinations of features of different embodiments fall within the scope of the invention and together form different embodiments that will be understood by professionals. For example, in the following claims all claimed embodiments can be used in each combination.

The description given herein contains several specific details. However, the embodiments of the invention are applied without these specific details. In other cases, known methods, structures and techniques were not detailed in order to keep this description clear.

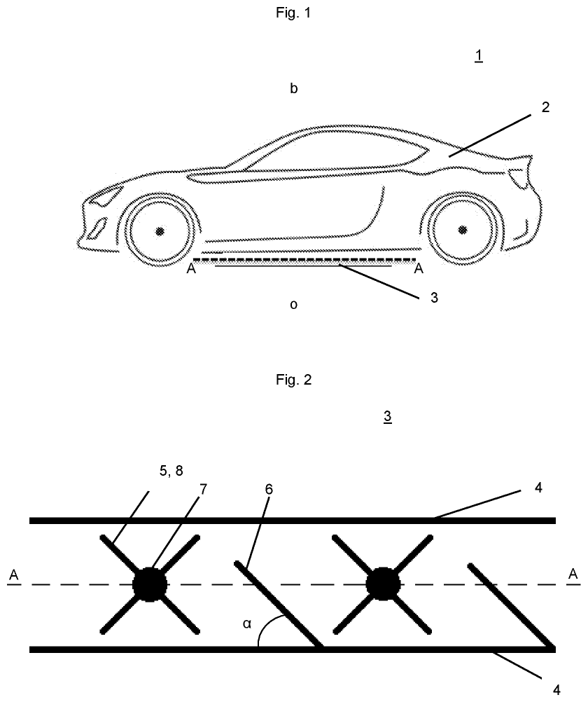

FIG. 1 shows a side view of an energy recovery system (1) for a vehicle (2) for the conversion of wind energy into electricity according to the invention. The energy recovery system (1) comprises at least a rechargeable battery (not shown), a wind collection device (3) for the conversion of wind energy into electricity and a control module (not shown) to transfer electricity generated by the wind collection device (3) to electricity-consuming components of the vehicle and/or the rechargeable battery from the wind collection device (3). Wind collection device (3) positioned underneath the vehicle (2) to capture air flowing below the vehicle (2). Alternatively (not shown), the wind collection device (3) may be positioned on the right or left side, at the front of or above the vehicle (2) to capture wind flowing along the right, left, front or over the top respectively. When the vehicle moves forward, the wind collection device (3) collects air flowing along its axis of symmetry (A). The air flow follows the horizontal plane of the vehicle's movement, and is therefore parallel to the top and bottom of the wind collection device shown here, where the orientation of the housing's top and bottom correspond with the vehicle's top (b) and bottom (o). The ventilators (5), deflectors (6) and energy converter (7) present inside the wind collection device are not shown here.

FIG. 2 shows an overhead view of a wind collection device (3) for the conversion of wind energy into electricity according to an embodiment of the invention, as may be present in FIG. 1. The wind collection device (3) comprises a housing (4) forming a flow passage. Preferably, the housing (4) is made of plastic. Alternatively, the housing (4) may be made of metal. Preferably, the housing (4) is bar-shaped, with a rectangular cross-section. Alternatively, the cross-section of the housing (4) can have the form of a circle, an oval, a rectangle, a square, an equilateral triangle or a regular convex polygon. Preferably, the housing (4) has an axis of symmetry (A) determining a direction of the air flow. Preferably, the housing (4) is open at the sides which are perpendicular to the axis of symmetry (A). Preferably, the wind collection device (3) comprises a filter (not shown) on at least one of the open sides of the housing (4). Preferably, the position of the filter is upwind relative to the air flow. The wind collection device (3) further comprises at least two ventilators (5) in the flow path of air flowing through the flow passage of the wind collection device (3). Preferably, the ventilators (5) are made of plastic. Alternatively, the ventilators (5) may be made of metal. The ventilator (5) preferably comprises a rotor shaft (B) located along the axis of symmetry (A) of the housing (4) of the wind collection device (3). Preferably, the ventilator (5) rotor shaft (B) is substantially perpendicular to the axis of symmetry (A) and therefore, centred within the housing and perpendicular to the direction of air flow. The ventilator (5) of the wind collection device (3) shall preferably comprise at least one rotating blade (8). Preferably, the ventilator (5) comprises four rotating blades (8). Preferably, the shape of the blade(s) (8) is straight. Preferably, the ventilator (5) is positioned in the housing (4) in such a way that the distance between the blade(s) (8) and each of the four parallel sides of the housing (4) is minimised relative to the axis of symmetry (A). The wind collection device (3) also comprises at least one deflector (6) to direct and accelerate air through the flow passage. Preferably, the deflector (6) of the wind collection device (3) is positioned upwind relative to the ventilators (5). Preferably, the deflector (6) is positioned at an angle (α) relative to one side of the housing (4) that is less than 50°. Preferably, the deflector (6) narrows the flow passage to ⅓ of the surface. Preferably, the number of deflectors (6) is equal to the number of ventilators (5). Preferably, each of the deflectors (6) is positioned upwind relative to each of the ventilators (5). Preferably, the deflectors of the wind collection device (3) are positioned on the same side of the housing. The wind collection device (3) further comprises at least one energy converter (7) for the conversion of wind energy into electricity. Preferably, the energy converter (7) of the wind collection device (3) is located along the ventilator (5) rotor shaft (B). Preferably, at least an operational connection is provided between one or more energy converters (7) and the rechargeable battery of the vehicle.

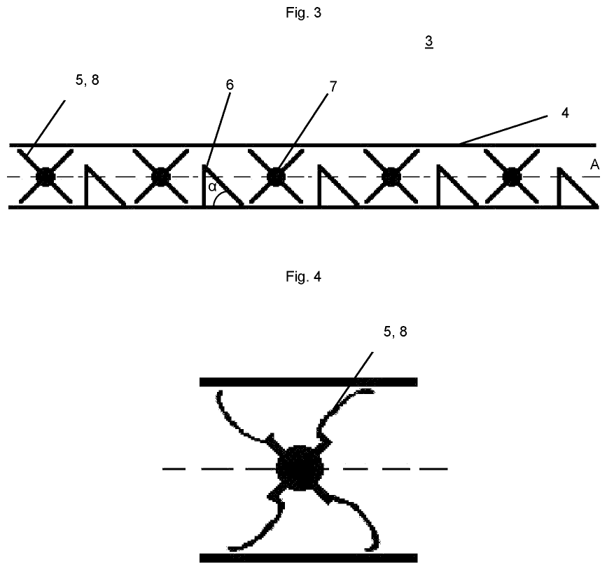

FIG. 3 shows an overhead view of a wind collection device (3) for the conversion of wind energy into electricity according to an embodiment of the invention. The wind collection device (3) was described in detail in FIG. 2. This figure clearly shows that the wind collection device (3) comprises multiple ventilators (5) and multiple deflectors (6). Preferably, one of the ventilators (5) for the wind collection device (3) is positioned in between two deflectors. Preferably, the shape of the deflector(s) (6) is triangular. Compared to the deflectors (6) shown in FIG. 2, with this triangular shape, the rear section of the deflector, i.e. downwind of the air flow, is closed. It has been determined that closing deflectors at the rear contributes to significantly reduced turbulence in the air flow behind the deflector, enabling a more efficient conversion of wind energy into electricity.

FIG. 4 shows an overhead view of a ventilator (5) of the wind collection device (3) for the conversion of wind energy into electricity according to an embodiment of the invention. Preferably, the ventilator (5) rotating blade (8) of the wind collection device (3) is a cambered airfoil.

11. An energy recovery system for a vehicle for conversion of kinetic wind energy into electricity, the energy recovery system comprising:
at least one rechargeable battery;
a wind collection device for the conversion of the kinetic wind energy into electricity;
a control module to transfer electricity generated by the wind collection device to electricity-consuming components of the vehicle and/or the rechargeable battery from the wind collection device,
wherein:
the wind collection device comprises:
a housing forming a flow passage having a surface area,
at least two ventilators in the flow passage,
a number of deflectors equal to a number of the at least two ventilators to direct and accelerate air through the flow passage, and
at least one energy converter for the conversion of the kinetic wind energy into electricity;
the housing of the wind collection device has an axis of symmetry determining a direction of the air flow;
the ventilators each comprise a rotor shaft that is substantially perpendicular to the axis of symmetry of the housing;
each of the deflectors of the wind collection device is positioned upwind relative to the ventilators; and
the axis of symmetry of the housing lies in a horizontal plane of movement of the vehicle.

12. The energy recovery system according to claim 11, wherein the deflector is positioned at an angle of less than 50° relative to one side of the housing.

13. The energy recovery system according to claim 11, wherein the deflector reduces the surface area of the flow passage by one-third.

14. The energy recovery system according to claim 11, wherein the deflectors of the wind collection device are positioned on a same side of the housing.

15. The energy recovery system according to claim 11, wherein one of the ventilators for the wind collection device is positioned between two of the deflectors.

16. The energy recovery system according to claim 11, wherein the energy converter of the wind collection device is located on the rotor shaft of the ventilator.

17. The energy recovery system according to claim 11, comprising at least one operational connection between one or more energy converters and the at least one rechargeable battery.

18. The energy recovery system according to claim 11, wherein the ventilators of the wind collection device comprise at least one rotating blade.

19. The energy recovery system according to claim 11, wherein the ventilators are vertical axis wind turbines.

20. The energy recovery system according to claim 19, wherein:
the ventilators of the wind collection device comprise at least one rotating blade; and
the at least one rotating blade is a cambered airfoil.
